(19) United States
(12) Patent Application Publication
(10) Pub. No.: US 2016/0381460 A1
(43) Pub. Date: Dec. 29, 2016

(54) NOVEL DIAPHRAGM AND A HEADPHONE DRIVER MADE THEREWITH

(71) Applicant: Li-Yuan Chiang, Dongguan City (CN)

(72) Inventor: Li-Yuan Chiang, Dongguan City (CN)

(73) Assignee: Dong Guan Shi Zheng Ren Electronic Co., Ltd., Dongguan City (CN)

(21) Appl. No.: 15/049,114

(22) Filed: Feb. 21, 2016

(30) Foreign Application Priority Data
Jun. 25, 2015 (CN) 201520448523.2

(51) Int. Cl. H04R 7/12; H04R 9/06

(52) U.S. Cl. CPC H04R 7/122; H04R 9/06; H04R 2307/025

(57) ABSTRACT

A novel diaphragm and a headphone driver made therewith, which comprises diaphragm substrate and diamond-like carbon coating plated on the diaphragm substrate; the amorphous diamond-like carbon coating (ADLC) being made of non-crystalline diamond material, the amorphous diamond-like carbon coating (ADLC) defining a mixture of sp3-structure diamond and sp2-structure graphite carbon which can effectively enhance the details, clarity and fidelity of music based on the high hardness, excellent heat conductivity as well as treble vibration frequency up to 70 KHz, so as to satisfy the requirements of high-end market consumers.

### BACKGROUND OF INVENTION

1. Field of the Invention

The present invention generally relates to a technical field of a headphone driver, more particularly to a novel diaphragm and a headphone driver made therewith.

2. Description of Related Art

For a long time, audio engineers have been expecting a diaphragm material which is both light and rigid. Diamond perfectly has the above characteristics. In a frequency response curve, the so-called resonant frequency usually refers to the frequency position where “resonance is strongest”, instead of the frequency position where “resonance starts”. Take aluminum diaphragm with thickness of 50 μm for example, the first resonant frequency is around 28.5 KHz, which seemingly exceeds the hearing range of human ear (20 Hz˜20 KHz), but as a matter of fact, at a position close to this range (e.g., 20.5 KHz), the diaphragm has probably started to resonate slightly, and the sound heard by the human ear is distorted, In view of this, for the sake of natural hearing, the resonance behavior at positions close to 20 KHz has become an important standard when choosing diaphragm materials. Generally speaking, the straighter the frequency response curve is, the later the first resonance frequency will occur, and the better the quality of the tweeter will be.

The dynamic drivers and balanced armature drivers used by headphones or earphones in the current market all adopt other types of diaphragm materials, and none of them can produce the clean and natural acoustical quality as well as non-distortion up till 40 KHz as required by headphones or earphones in the Hi-Fi market.

### SUMMARY OF THE INVENTION

In view of the shortcomings of the prior art, the present invention provides a novel diaphragm and a headphone driver made therewith, which can effective enhance the details, clarity and fidelity of music.

Comparing to the prior art, the present invention has obvious advantages and efficacies in achieving clean and natural acoustical quality as well as non-distortion up till 40 KHz as required by headphones or earphones in the Hi-Fi market. The present invention adopts a new type of amorphous diamond-like carbon (ADLC) coating, which is made of non-crystalline diamond material. The amorphous diamond-like carbon (ADLC) coating is a mixture of sp3-structure diamond and sp2-structure graphite carbon. It remains the most diamond properties such as chemical inertness, high mechanical hardness, high Young's modulus and high sound conduction velocity with the combination of low density.

It can effectively enhance the details, clarity and fidelity of music based on the high hardness, excellent heat conductivity as well as treble vibration frequency up to 40 KHz, so as to satisfy the requirements of high-end earphone/headphone market consumers.

### BRIEF DESCRIPTION OF THE DRAWINGS

FIG. 1: a perspective view of a headphone driver of the present invention;

FIG. 2: a sectional view of the headphone driver of the present invention;

FIG. 3: an exploded view of the headphone driver of the present invention;

FIG. 4: a sectional view of a diaphragm of the present invention;

FIG. 5: an exploded view of the diaphragm of the present invention; and

FIG. 6: a frequency response curve of the diaphragm of the present invention.

### DETAILED DESCRIPTION OF THE INVENTION

Below are detailed descriptions of the present invention with reference to the accompanying drawings:

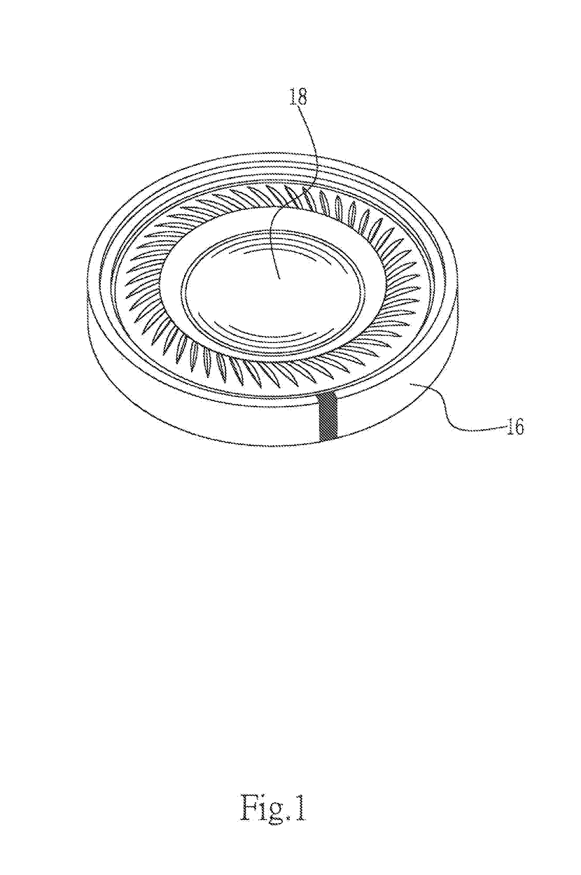

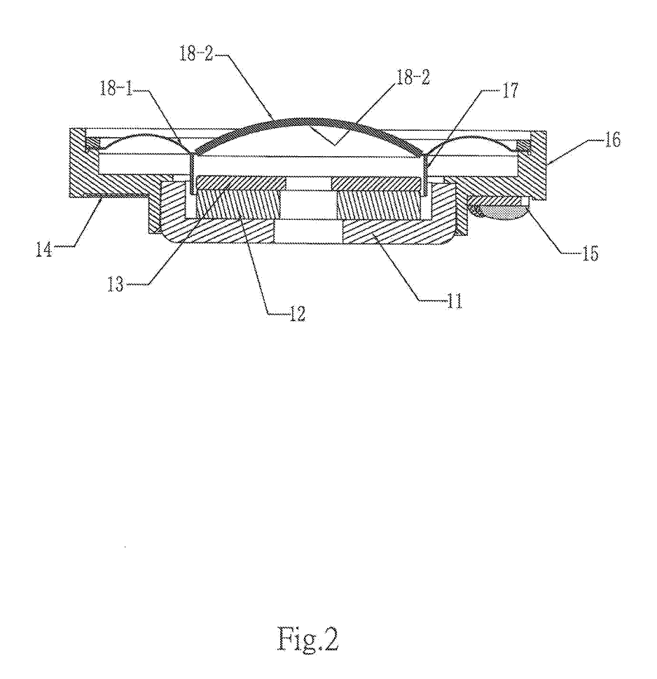

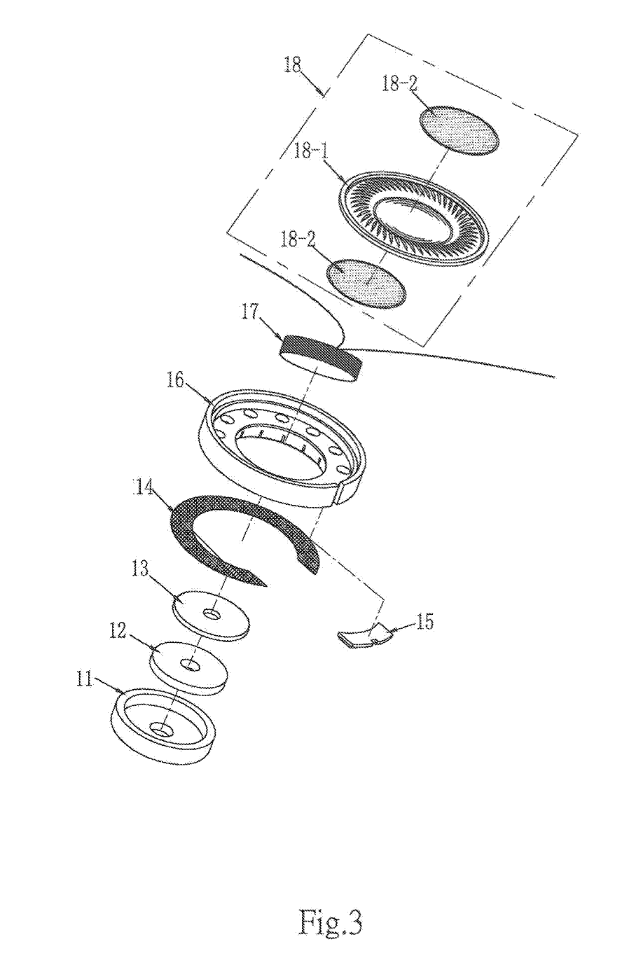

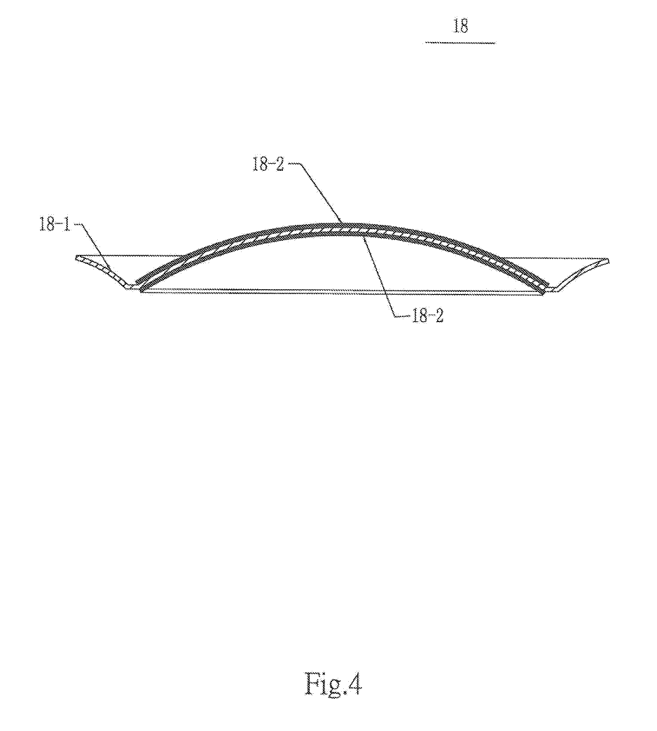

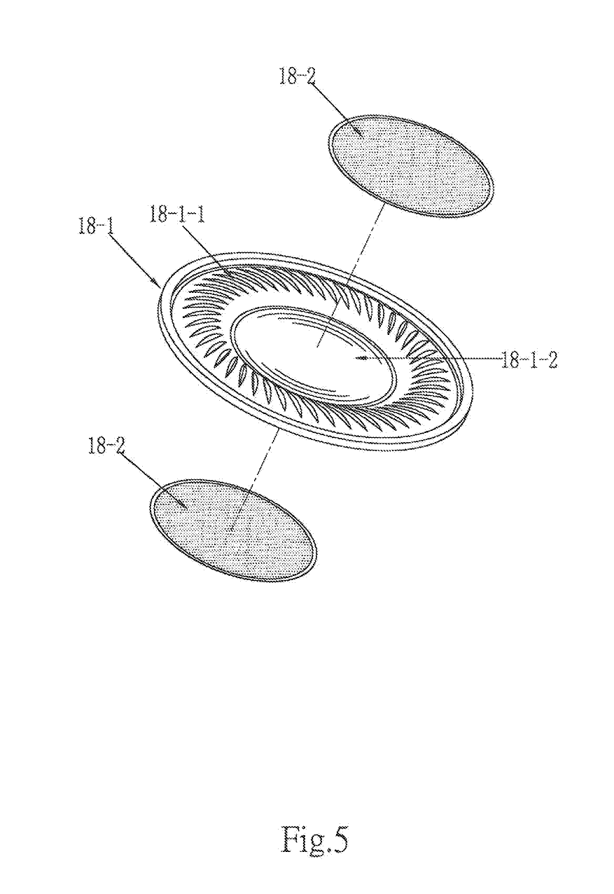

Referring to FIG. 1 to FIG. 5, which depict the detailed structure of a preferred embodiment of the present invention, a headphone driver comprises a yoke (11), a magnet (12), a spring washer (13), a tuning paper (14), a PCB board (15), a frame (16), a voice coil (17), and a diaphragm (18).

Specifically, the yoke (11), tuning paper (14) and PCB board (15) are installed on the frame (16), the yoke (11) is configured with a U groove, the magnet (12) and spring washer (13) are positioned inside the U groove, a gap is provided between the periphery of the magnet (12) and spring washer (13) and the inner walls of the U groove, the voice coil (17) is positioned on the diaphragm (18), and the voice coil (17) partially extends into the gap.

The diaphragm (18) comprises a diaphragm substrate (18-1) and an amorphous diamond-like carbon (ADLC) coating (18-2) plated on the diaphragm substrate (18-1). The diamond-like carbon coating (ADLC) (18-2) is made of non-crystalline diamond material. The amorphous diamond-like carbon (ADLC) coating (18-2) is a mixture of sp3-structure diamond and sp2-structure graphite carbon.

The thickness of the diaphragm substrate (18-1) is 6 μm to 125 μm; the diaphragm substrate (18-1) includes any of PET, PEN, PEEK, TPU, POL or PEI. The thickness of amorphous diamond-like carbon (ADLC) coating. (18-2) is 100 nm to 500 nm; and the diameter of the frame 16 is 5 mm to 85 mm.

### Embodiment 1

There are two amorphous diamond-like carbon (ADLC) (18-2) coatings. The two amorphous diamond-like carbon (ADLC) (18-2) coatings are respectively plated on the top and the bottom surfaces of the diaphragm substrate (18-1).

### Embodiment 2

There is only one amorphous diamond-like carbon (ADLC) coating (18-2). The diamond-like carbon coating (ADLC) (18-2) is plated on either the top surface or the bottom surface of the diaphragm substrate (18-1).

### Embodiment 3

The diaphragm substrate (18-1) comprises a folding edge portion (18-1-1) and a treble portion (18-1-2). The amorphous diamond-like carbon (ADLC) coating (18-2) is plated on the surface of any of the folding edge portion (18-1-1), treble portion (18-1-2) or the whole diaphragm substrate (18-1).

Below are the testing data and analysis of the diaphragm of the present invention and the headphone driver made of the diaphragm of the present invention:

1. The resonance frequency of the diaphragm made on the basis of the present invention and the “Young's Modulus” of the material are closely related to the “density” of the material. From the resonance frequency coefficient in Table 1, it can be deduced that, when the thickness of the diamond diaphragm is 40 μm, the first resonance frequency can be as high as 80.8 KHz; based on the testing, the diamond tweeter maintains a straight curve before 40 KHz, without any resonance. This is incomparable by any other common tweeter diaphragm materials such as Aluminum, Beryllium or Titanium).

| | Aluminum | Beryllium | Titanium | ADLC |
|---|---|---|---|---|
| Young's modulus (GPa) | 71 | 318 | 120 | 347 |
| Density (k/m3) | 2700 | 1850 | 4500 | 1800 |
| Sound Velocity C(km/s) | 5.2 | 12.3 | 5.2 | 18.3 |

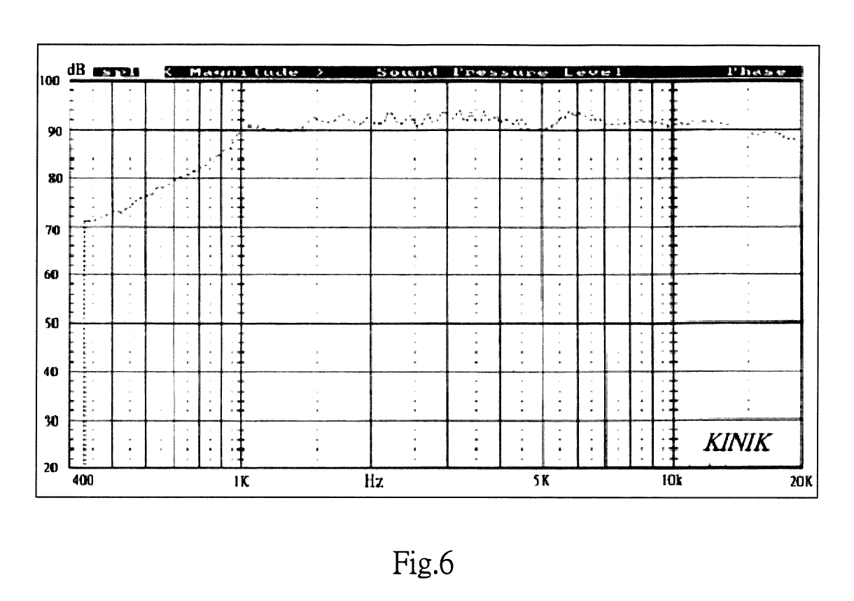

2. As indicated by the frequency response curve of the diaphragm made on the basis of the present invention from 400Hz to 20 kHz, till 20 kHz, the curve largely maintains straight, without any serious resonance (see FIG. 6).

The key point of the present invention is to achieve clean and natural acoustical quality as well as non-distortion up till 40 KHz as required by headphones or earphones in the Hi-Fi market, The present invention adopts a novel amorphous diamond-like carbon (ADLC) coating, when can effectively enhance the details, clarity and fidelity of music based on the high hardness, excellent heat conductivity as well as treble vibration frequency up to 40 KHz, so as to satisfy the requirements of high-end headphone market consumers.

Although the invention has been explained in relation to its preferred embodiment, it is to be understood that many other possible modifications and variations can be made without departing from the spirit and scope of the invention as hereinafter claimed.

I claim:

1. A novel diaphragm, comprising:
a diaphragm substrate (184) and an amorphous diamond-like carbon (ADLC) coating plated on the diaphragm substrate 18-1);
wherein the amorphous diamond-lie carbon (ADLC) coating is made of non-crystalline diamond material; the amorphous diamond-like carbon (ADLC) coating (18-2) is a mixture of sp3-structure diamond and sp2-structure graphite carbon;
wherein the thickness of the diaphragm substrate (18-1) is 6 μm to 125 μm; the thickness of the amorphous diamond-like carbon coating (18-2) is 100 nm to 500 nm.

2. The diaphragm defined in claim 1, wherein the diaphragm substrate (18-1) comprises one of the following: PET, PEN, PEEK, TPU, POL or PEI.

3. The diaphragm defined in claim 1, wherein the diaphragm substrate is configured with the amorphous diamond-like carbon coating (18-2) plated on either a top surface or a bottom surface thereof.

4. The diaphragm defined in claim 1, wherein the diaphragm substrate is configured with two amorphous diamond-like carbon coatings respectively plated on the top surface and the bottom surface thereof.

5. A headphone driver with a novel diaphragm defined in claim 1, comprises: a yoke (11), a magnet (12), a spring washer (13), a frame (16), a voice coil (17), a tuning paper (14), a PCB board (15) and a diaphragm (18); the yoke (11), tuning paper (14) and PCB board (15) being installed on the frame (16); the yoke (11) configured with a U groove, the magnet (12) and spring washer (13) positioned inside the U groove, a gap being disposed between a periphery of the magnet (12) and spring washer (13) and inner walls of the U groove; the voice coil (17) positioned on the diaphragm (18), and the voice coil (17) partially extending into the gap;
wherein the diaphragm (18) comprises a diaphragm substrate (18-1) and an amorphous diamond-like carbon coating (18-2) plated on the diaphragm substrate (18-1).

6. The headphone driver defined in claim 5, wherein the thickness of the diaphragm substrate (18-1) is 6 μm to 125 μm; the thickness of the amorphous diamond-like carbon coating (18-2) is 100 nm to 500 nm; the diameter of the frame (16) is 5 mm to 85 mm.

7. The headphone driver defined in claim 5, wherein the diaphragm substrate (18-1) comprises one of the following: PET, PEN, PEEK, TPU, POI, or PET.

8. The headphone driver defined in claim 5, wherein the diaphragm substrate is configured with the amorphous diamond-like carbon coating (18-2) plated on either a top surface or a bottom surface thereof.

9. The headphone driver defined in claim 5, wherein the diaphragm substrate is configured with two amorphous diamond-like carbon coatings respectively plated on the top surface and the bottom surface thereof.

10. The headphone driver defined in claim 5, wherein the diaphragm substrate (18-1) comprises folding edge portions (18-1-1) and treble portions (18-1-2); the amorphous diamond-like carbon coating (18-2) is plated on a surface of any of the folding edge portion (18-1-1), treble portion (18-1-2) or the whole diaphragm substrate (18-1).
